(19) United States
(12) Patent Application Publication
(10) Pub. No.: US 2008/0094470 A1
(43) Pub. Date: Apr. 24, 2008

(54) SURVEILLANCE SECURITY SYSTEM AND METHOD

(75) Inventors: Shih-Fang Wong, Shenzhen (CN); Tsung-Jen Chuang, Shenzhen (CN); Lin-Kun Ding, Shenzhen, Guangdong (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/627,358

(22) Filed: Jan. 25, 2007

(30) Foreign Application Priority Data
Oct. 20, 2006 (CN) 200610063218.7

(51) Int. Cl. H04N 7/18

(52) U.S. Cl. 348/143

(57) ABSTRACT

A surveillance security system is used for selectively storing motion image data of an object to be detected. The surveillance security system includes an image-capturing device for capturing images from an object; a memory module for storing the image data; and a controller for controlling a storage process of the memory module. The controller includes a sampling module for taking a plurality of image frames from the image data; and a control-signal generating module for receiving the image frames and generating a write enable signal by comparing the image frames, wherein the write enable signal is used for controlling the storage process of the memory module. A surveillance security method for selectively storing motion image data of an object is also disclosed.

### BACKGROUND OF THE INVENTION

1. Field of the Invention

The present invention generally relates to surveillance security systems and methods, and more particularly to a surveillance security system and method capable of selectively storing motion monitored images.

2. Description of Related Art

Nowadays, there is an increasing demand of security control as a frame countermeasure for protecting wealth not to be violated. It is also need to utilize a safety guard in industrial application and the like. There is also an increasing demand for remote monitoring by which users can gather real-time information of an object.

A monitoring apparatus usually includes an image-capturing device, a storing device, and a playback device. A camera can be used as the image-capturing device, which is capable of capturing images of an object to be detected in a monitored area. The images are stored in the storing device and then displayed to users by the playback device, thus the users can gather real-time information about the object.

The images taken by the image-capturing device do not always change. Since stationary images are invaluable for monitoring, the users would have the images that are stored in the storing device played back after a period of time instead of continuously staring at the displayed images. Thus, the storing device needs to have a great amount of storing space for storing lots of the changeless images.

Therefore, a surveillance security system and method are needed in the industry to selectively store motion images or motion videos.

### SUMMARY OF THE INVENTION

A surveillance security system includes an image-capturing device, a memory module, and a controller. The image-capturing device is used for capturing a stream of images from an object to be detected, and generating image data. The memory module is used for storing the image data. The controller is used for controlling a record process of the memory module. The controller includes a sampling module and a control-signal generating module. The sampling module is for taking a plurality of image frames from the image data. The control-signal generating module is used for receiving the image frames, and generating a write enable signal by comparing the image frames, wherein the write enable signal is used for controlling the storage process of the memory module.

A surveillance security method comprising following steps of: capturing a stream of images from an object to be detected; generating image data; capturing a plurality of image frames from the image data; comparing the image frames for determining a motion and/or stationary state of the object; and enabling and/or disabling a storing process of the image data according to the motion and/or stationary state of the object.

Other systems, methods, features, and advantages of the present surveillance security system and method will be or become apparent to one with skill in the art upon examination of the following drawings and detailed description. It is intended that all such additional systems, methods, features, and advantages be included within this description, be within the scope of the present system and method, and be protected by the accompanying claims.

### BRIEF DESCRIPTION OF THE DRAWINGS

Many aspects of the present surveillance security system and method can be better understood with reference to the following drawings. The components in the drawings are not necessarily to scale, emphasis instead being placed upon clearly illustrating the principles of the inventive system and method. Moreover, in the drawings, like reference numerals designate corresponding parts throughout the several views.

FIG. 1 is a block diagram of a surveillance security system in accordance with an exemplary embodiment;

FIG. 2 is a more detailed block diagram illustrates the exemplary embodiment of the surveillance security system;

FIG. 3 is a flow chart in accordance with a first exemplary embodiment of a surveillance security method; and

FIG. 4 is a flow chart of the surveillance security method in accordance with a second exemplary embodiment with reference to the surveillance security system as illustrated in FIG. 2.

### DETAILED DESCRIPTION OF THE INVENTION

Reference will now be made to the drawings to describe a preferred embodiment of the present surveillance security system and preferred embodiments of the present surveillance security method.

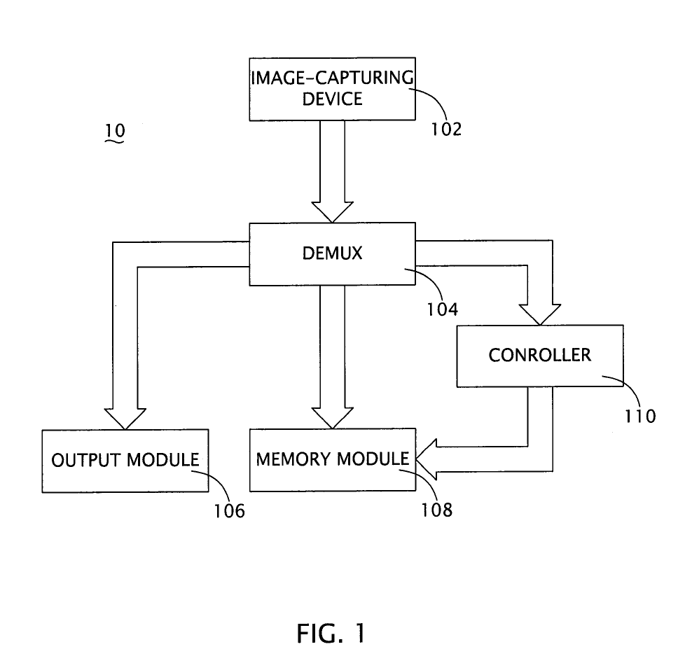

Referring to FIG. 1, a block diagram of a surveillance security system 10 in accordance with an exemplary embodiment is illustrated. The surveillance security system 10 includes an image-capturing device 102, a data de-multiplexer (DEMUX) 104, an output module 106, a memory module 108, and a controller 110. The image-capturing device 102 can be a camera or camcorder capable of capturing a stream of images of an object to be detected in a monitored area. The image-capturing device 102 generates image data containing information about the object to be detected, and then outputs the image data to the DEMUX 104. The DEMUX 104 delivers the image data to the output module 106, the memory module 108, and the controller 110. The output module 106 may be any kind of display screen, which is capable of displaying the images. The controller 110 controls the memory module 108 to perform a record process of the image data.

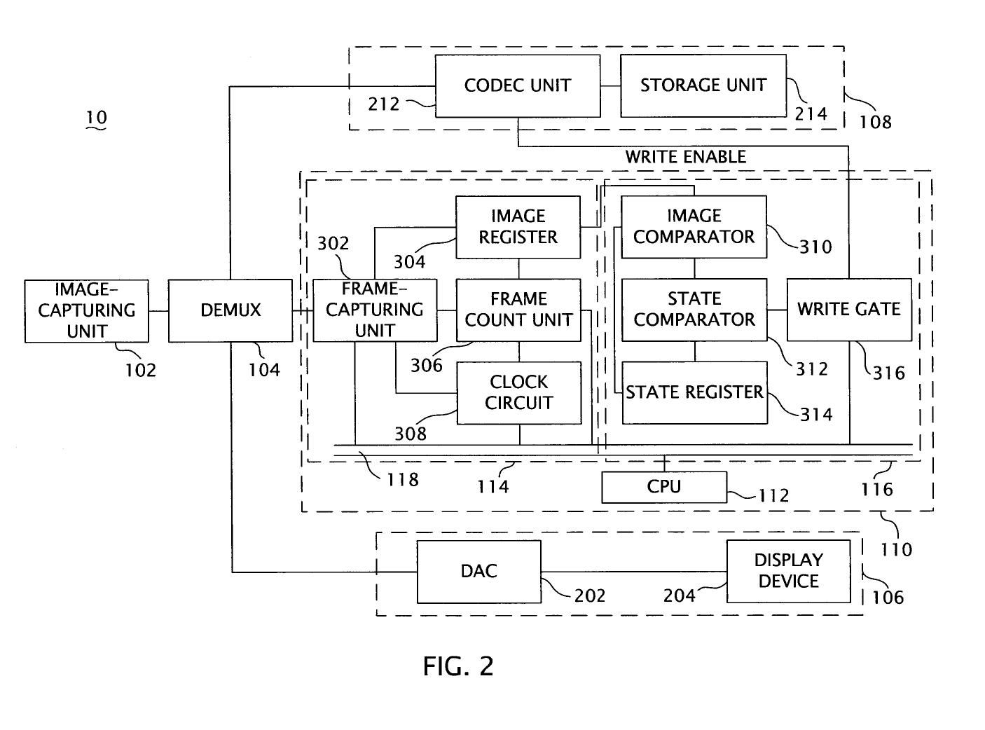

Referring to FIG. 2, a more detailed diagram illustrates the exemplary embodiment of the surveillance security system 10 as shown in FIG. 1.

The output module 106 includes a digital to analog converter (DAC) 202 and a display device 204. The DAC 202 converts the image data delivered from the DEMUX 104 to analog signals, and sends the analog signals to the display device 204. The display device 204 displays the images. In other alternative embodiments, the display device 204 may process the data image digitally, and the DAC 202 can be omitted.

The memory module 108 includes a codec unit 212 and a storage unit 214. The codec unit 212 is electrically coupled to the controller 110. The codec unit 212 may code the image data delivered by the DEMUX 104 according to a control instruction sent by the controller 110. To be more exactly, when the record process is required, the controller 110 sends a write instruction to the codec unit 212. The codec unit 212 codes the image data accordingly, and then generates coded image data. The coded image data are sent to the storage unit 214 to be stored. Alternatively, the storage unit 214 may store the image data that has not been coded, furthermore, the storage unit 214 may be connected to the controller 110 to receive the control instruction, that way, the coded unit 212 may be omitted. That is, the storage unit 214 records the image data delivered by the DEMUX 104 when the write instruction is sent by the controller 110.

The controller 110 includes a central processing unit (CPU) 112, a sampling module 114, and a control-signal generating module 116. Generally, the CPU 112 communicates with the sampling module 114 and the control-signal generating module 116 via a bus 118, for enabling or disabling working processes thereof.

The sampling module 114 includes a frame-capturing unit 302, an image register 304, a frame count unit 306, and a clock circuit 308. The frame-capturing unit 302 is connected to the DEMUX 104 and the clock circuit 308. The frame-capturing unit 302 is used for capturing an image frame from the image data forwarded by the DEMUX 104 when the clock circuit 308 sends a capture enable signal. The frame-capturing unit 302 sends the image frame to the image register 304, and sends an add frame signal to the frame count unit 306 simultaneously. When the add frame signal is received, the frame count unit 306 updates a frame counter by incrementing the frame counter by one. When the frame counter stored in the frame count unit 306 reaches a predetermined frame count, the frame count unit 306 sends an image send signal to the image register 304, for instructing the image register 304 to send the image frames to the control-signal generating module 116. Here, the predetermined frame count should be at least two. As an example, two image frames are described below. The clock circuit 308 is connected with the frame-capturing unit 302, for sending a capture enable signal to the frame-capturing unit 302 at a predetermined interval.

The control-signal generating module 116 includes an image comparator 310, a state comparator 312, a state register 314, and a write gate 316. The image comparator 310 is connected to the image register 304, for comparing the two image frames sent from the image register 304. The image comparator 310 generates a current state signal that indicates whether the object in the monitored area is in a motion state or in a stationary state. The current state signal is sent to the state register 314 to be stored.

The state comparator 312 is connected to the image comparator 310 and is for receiving the current state signal generated based on a current comparison. The state comparator 312 is also connected to the state register 314 for receiving a previous state signal generated based on a previous comparison. The state comparator 312 generates a record control signal according to the current state signal and the previous state signal, and sends the record control signal to the write gate 316. The write gate 316 thus sends either of a write enable signal or a write disable signal to the codec unit 212 (if necessary) or the storage unit 214, thus controlling the record process of the memory module 108.

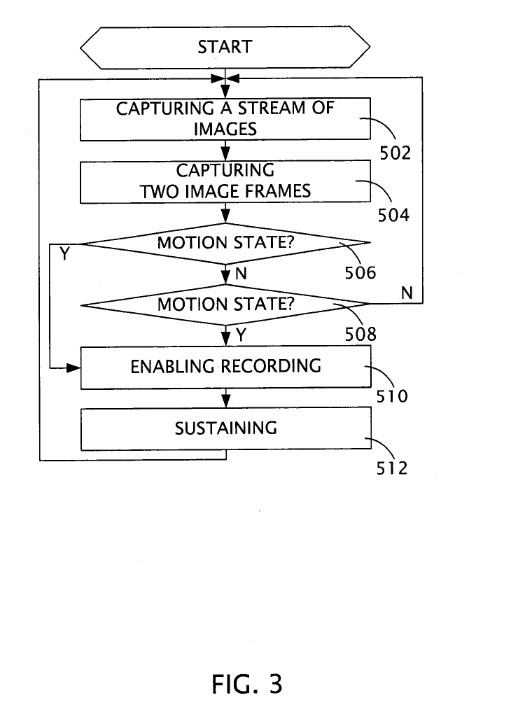

Referring now to FIG. 3, a flow chart illustrates an exemplary embodiment of a surveillance security method. Firstly, in step 502, a stream of images of the object to be detected in the monitored area is captured, and the image data is generated.

Secondly, in step 504, two image frames are captured from the image data.

Next, in step 506, the two image frames are compared to determine whether the object is in the motion or the stationary state.

In step 508, if the object is in the stationary state, the previous state of the object is retrieved.

In step 510, if the object is in the motion state, or if the previous state of the object retrieved in the step 508 shows that the object is previously in the motion state, the record process of the image data is enabled.

In step 512, the record process is enabled and sustained for a predetermined time. Step 502 is executed then, for starting a new iteration.

If in the step 508 shows that the object is previously in the stationary state, the record process is not enabled, and step 502 will then be executed to start a new iteration.

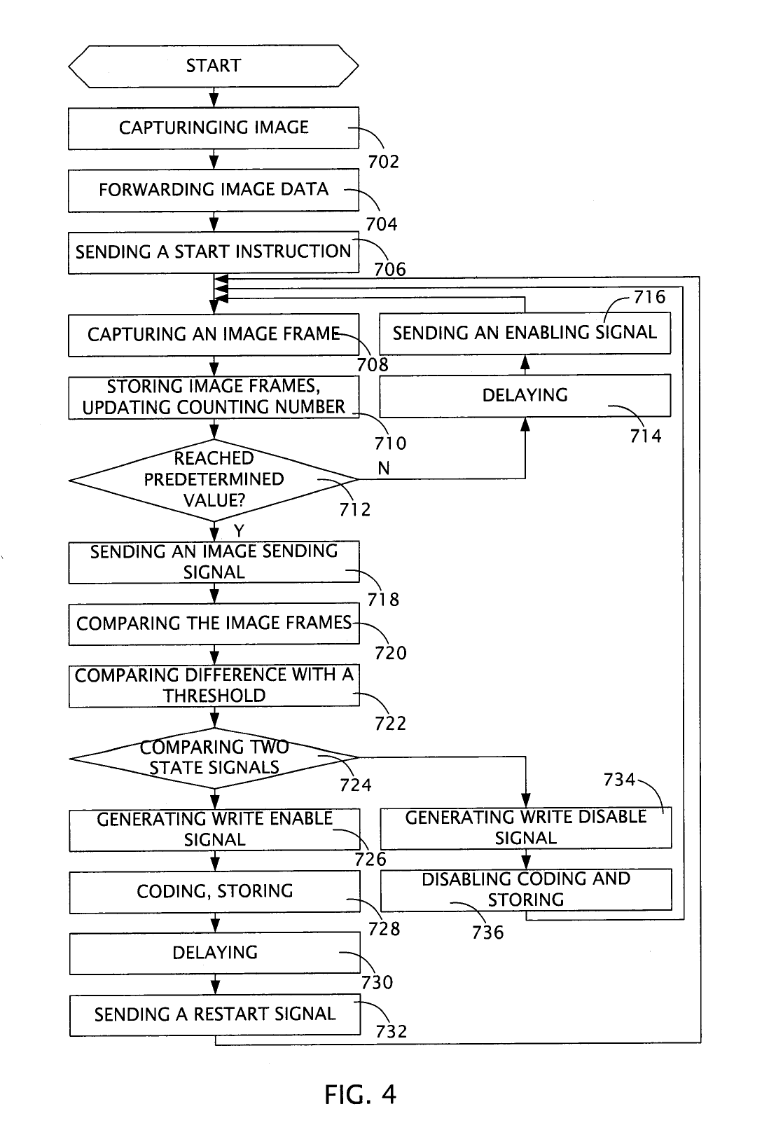

A second exemplary embodiment of the surveillance security method with reference to the surveillance security system 10 is illustrated in FIG. 4.

Firstly, the imaging-capturing unit 102 captures the stream of images from the object to be detected in the monitored area to generate the image data, and sends the image data to the DEMUX 104 (step 702).

Secondly, the DEMUX 104 forwards the image data to the output module 106, the memory module 108, and the controller 110 (step 704).

Thirdly, the CPU 112 sends a start instruction to the bus 118, for instructing the frame-capturing unit 302, the frame count unit 306, and the clock circuit 308 in working (step 706).

Next, the frame-capturing unit 302 captures an image frame from the image data. The frame-capturing unit 302 sends the image frame to the image register 304 and sends the add frame signal to the frame count unit 306 simultaneously. The clock circuit 308 starts to time at the same time (step 708).

The image register 304 stores the image frame, and the frame count unit 306 updates the frame counter by incrementing the frame counter by one after receiving the add frame signal (step 710). If a default value of the frame counter is 0, it becomes 1 when a first image frame is captured and stored, and 2 when a second image frame is captured and stored.

The frame count unit 306 detects whether the frame counter has reached a predetermined count (step 712).

If the frame counter is less than the predetermined count, the frame-capturing unit 302 does not take an image frame until the clock circuit 308 reaches the predetermined interval. That is, the frame-capturing unit 302 is delayed (step 714).

The clock circuit 308 sends the enabling signal to the capturing unit 302 when the clock circuit 308 reaches the predetermined interval (step 716), and then step 708, step 710, and step 712 will be executed.

If the frame counter is not less than the predetermined count, the frame count unit 306 sends the image send signal to the image register 304, for instructing the image register 304 to send the two image frames to the control signal generating module 116 (step 718).

The image comparator 310 compares the two image frames, and generates a difference value of the image frames (step 720).

The difference value is compared with a predetermined threshold to compute whether the object is in the motion or stationary state. The current state signal is generated based on the compared result, and the current state signal is sent to the state comparator 312 and the state register 314 (step 722). For example, when the difference value is less than the threshold, it is concluded that the object is in the stationary state; when the difference value is greater than the threshold, it is concluded that the object is in the motion state.

The state comparator 312 receives the previous state signal sent by the state register 314, and compares the previous state signal with the current state signal sent by the image comparator 304, and generates a record control signal that is to be sent to the write gate 316 (step 724). A relationship between the current state signal, the previous state signal, and the record control signal is listed in the table below.

| Current state signal | Previous state signal | Record control signal |
|---|---|---|
| 1 | 0 | Enable |
| 0 | 0 | Disable |
| 1 | 1 | Enable |
| 0 | 1 | Enable |

### Wherein “1” in the first and second rank of the table indicates that the object is in the motion state, and “0” indicates that the object is in the stationary state.

The write gate 316 generates the write enable signal according to the “enable” record control signal that is sent by the state comparator (step 726).

The codec unit 212 codes the image data sent from the DEMUX 104 according to the write enable signal, and the storage unit 214 stores the coded image data (728). In another embodiment, the coding process may be omitted.

The write enable signal sent by the write gate 316 lasts for a predetermined enabled time (step 730). The enabled time may, as an example, be 1 minute.

At the end of the enabled time, the write gate 316 sends a restart signal to the CPU 112 through the bus 118 to instruct the frame-capturing unit 302, the frame count unit 306, and the clock circuit 308 to start another iteration (step 732).

The write gate 316 generates the write disable signal according to the “disable” record control signal which is sent by the state comparator (step 734).

The codec unit 212 disables the coding process of the image data according to the write disable signal, and the storage unit 214 disables the storage process of the image data (step 736). That is, the coding or storage process stops if the write disable signal is received, or the coding or storage process remains disabled if it isn't in process when receiving the write disable signal. After that, the frame-capturing unit 302, the frame count unit 306, and the clock circuit 308 starts another iteration.

Based on the above surveillance security system and method, the image data taken from the object will be recorded only when the object is in a motion state, thus the image data can be recorded selectively. Thus, only useful information will be recorded, and a large amount of useless stationary image data will not be recorded, storing space can be saves.

What is claimed is:

1. A surveillance security system comprising:
an image-capturing device for capturing a stream of images from an object to be detected, and generating image data;
a memory module for storing the image data; and
a controller for controlling a record process of the memory module, wherein the controller comprises:
a sampling module for taking a plurality of image frames from the image data; and
a control-signal generating module for receiving the image frames, and generating a write enable signal by comparing the image frames, wherein the write enable signal is used for controlling the storage process of the memory module.

2. The surveillance security system as claimed in claim 1, wherein said surveillance security system further comprises a de-multiplexer for forwarding the image data to the controller and/or the memory module.

3. The surveillance security system as claimed in claim 1, wherein said sampling module comprises:
a frame-capturing unit for capturing an image frame from the image data;
a frame count unit for counting a quantity of the image frames captured by the frame-capturing unit; and
an image register for storing the image frames.

4. The surveillance security system as claimed in claim 3, wherein said sampling module further comprises a clock circuit for sending a capture enable signal to the frame-capturing unit in a predetermined interval, and the frame-capturing unit captures an image frame according to the capture enable signal.

5. The surveillance security system as claimed in claim 1, wherein said surveillance security system further comprises a central processing unit for sending instruction to the sampling module, for instructing the sampling module to work.

6. The surveillance security system as claimed in claim 1, wherein said control-signal generating module comprises:
an image comparator for receiving the image frames, and comparing the image frames to generate a current state signal, wherein the current state signal indicates that the object is in a motion and/or stationary state; and
a write gate for generating the write enable signal according to the motion and/or stationary state of the object, wherein the write enable signal is used for controlling the record process of the memory module.

7. The surveillance security system as claimed in claim 6, wherein said control-signal generating module further comprises a state comparator for comparing the current state signal with a previous state signal for generating a record control signal, wherein the record control signal is used for controlling the record process of the memory module.

8. The surveillance security system as claimed in claim 7, wherein said control-signal generating module further comprises a write gate, and the write gate is used for sending a write enable signal which lasts for a predetermined enabled time at an occurrence of receiving a first record control signal to enable the memory module to record the image data, and/or sending a write disable signal at the occurrence of receiving a second record control signal to disable the record process of the memory module.

9. A surveillance security method comprising following steps of:
capturing a stream of images from an object to be detected;
generating image data;
capturing a plurality of image frames from the image data;
comparing the image frames for determining a motion and/or stationary state of the object; and
enabling and/or disabling a storing process of the image data according to the motion and/or stationary state of the object.

10. The surveillance security method as claimed in claim 9, further comprising the following steps of:
capturing an image frame;
registering the image frame;
updating a frame counter by adding 1 thereto; and
sending the registered image frames to be compared at an occurrence that the frame counter reaches a predetermined count.

11. The surveillance security method as claimed in claim 10, further comprising the following step of: delaying a predetermined interval before taking another image frame.

12. The surveillance security method as claimed in claim 9, further comprising the following steps of:
comparing the plurality of image frames for determining a current state of the object;
registering the current state of the object;
comparing the current state with a previously registered state for generating a record control signal; and
enabling and/or disabling the storing process of the image data according to the record control signal.

13. The surveillance security method as claimed in claim 12, further comprising the following steps of:
comparing the plurality of image frames for an image difference value of the image frames; and
comparing the image difference value with a predetermined threshold for establishing a current state of the object.

14. The surveillance security method as claimed in claim 13, further comprising the following steps of:
determining a motion state of the object at the occurrence that the image difference value is no less than the threshold; and
determining a stationary state of the object at the occurrence that the image difference is less than the threshold.

15. The surveillance security method as claimed in claim 12, further comprising the following steps of:
generating an “enable” record control signal at the occurrence that at least one of the current state and the previous state indicating the motion state; and
generating a “disable” record control signal at the occurrence that both the current state and the previous state indicating the stationary state.

16. The surveillance security method as claimed in claim 15, wherein the “enable” record control signal is used for enabling the record process of the image data, and the “disable” record control signal is used for disabling the record process of the image data.

17. The surveillance security method as claimed in claim 15, further comprising the following steps of:
generating a write enable signal according to the “enable” record control signal, for enabling the storage process of the image data; and
generating a write disable signal according to the “disable” record control signal, for disabling the storage process of the image data.

18. The surveillance security method as claimed in claim 17, further comprising the following steps of:
storing the image data on receiving the write enable signal; and
sustaining the write enable signal for a predetermined enabled time.

19. The surveillance security method as claimed in claim 17, further comprising the following steps of:
terminating the storage process at the occurrence that the storage process is enabled on receiving the write disable signal; and
sustaining the disablement of the storage process at the occurrence that the storage process is disabled on receiving the write disable signal.

20. The surveillance security method as claimed in claim 9, further comprising the following steps of:
coding the image data before storing; and
reproducing the image of the object according to the image data.
